(19) United States
(12) Patent Application Publication
(10) Pub. No.: US 2016/0077610 A1
(43) Pub. Date: Mar. 17, 2016

(54) SYSTEM, TRANSMITTING DEVICE, RECEIVING DEVICE, TRANSMITTING METHOD, RECEIVING METHOD, AND NON-TRANSITORY COMPUTER READABLE MEDIUM

(71) Applicant: FUJI XEROX CO., LTD., Tokyo (JP)

(72) Inventor: Kiyoshi TASHIRO, Kanagawa (JP)

(73) Assignee: FUJI XEROX CO., LTD., Tokyo (JP)

(21) Appl. No.: 14/678,402

(22) Filed: Apr. 3, 2015

(30) Foreign Application Priority Data
Sep. 17, 2014 (JP) 2014-189372

(51) Int. Cl. G06F 3/038; G06F 3/0354

(52) U.S. Cl. CPC G06F 3/0383; G06F 3/0354

(57) ABSTRACT

A system includes an encoding unit, a mixing unit, an extracting unit, and a decoding unit. The encoding unit encodes information which is different from an operation input into a form of an operation input code for representing an operation input by a user. The mixing unit mixes the operation input code and the encoded information. The extracting unit extracts the encoded information from the mixture of the operation input code and the encoded information. The decoding unit decodes the extracted encoded information.

### CROSS-REFERENCE TO RELATED APPLICATIONS

This application is based on and claims priority under 35 USC 119 from Japanese Patent Application No. 2014-189372 filed Sep. 17, 2014.

### BACKGROUND

(i) Technical Field

The present invention relates to a system, a transmitting device, a receiving device, a transmitting method, a receiving method, and a non-transitory computer readable medium.

(ii) Related Art

In general operation systems and applications, causing an operation unit, such as a mouse or a keyboard, to transmit operation input information to a controller has been regarded as the standard. However, in order to transmit information different from operation input information to the controller, additional costs to separately provide a communication unit and the like are required.

In particular, in the case of remote desktop software, for example, it is effective to transmit information of a geographical location, a location on a network, an attitude of an operation device, a type of an operation device, or the like, which is different from operation input information, from a transmitting device to a receiving device.

### SUMMARY

According to an aspect of the invention, there is provided a system including an encoding unit, a mixing unit, an extracting unit, and a decoding unit. The encoding unit encodes information which is different from an operation input into a form of an operation input code for representing an operation input by a user. The mixing unit mixes the operation input code and the encoded information. The extracting unit extracts the encoded information from the mixture of the operation input code and the encoded information. The decoding unit decodes the extracted encoded information.

### BRIEF DESCRIPTION OF THE DRAWINGS

Exemplary embodiments of the present invention will be described in detail based on the following figures, wherein:

FIG. 1 is a diagram illustrating an example of a configuration of a system;

FIG. 2 is a diagram illustrating an example of a configuration of controllers;

FIG. 3 is a diagram illustrating an example of operation input information;

FIG. 4 is a diagram illustrating an example of encoded information; and

FIG. 5 is a diagram illustrating an example of an operation of a controller.

### DETAILED DESCRIPTION

Exemplary embodiments of the present invention will be described with reference to the accompanying drawings.

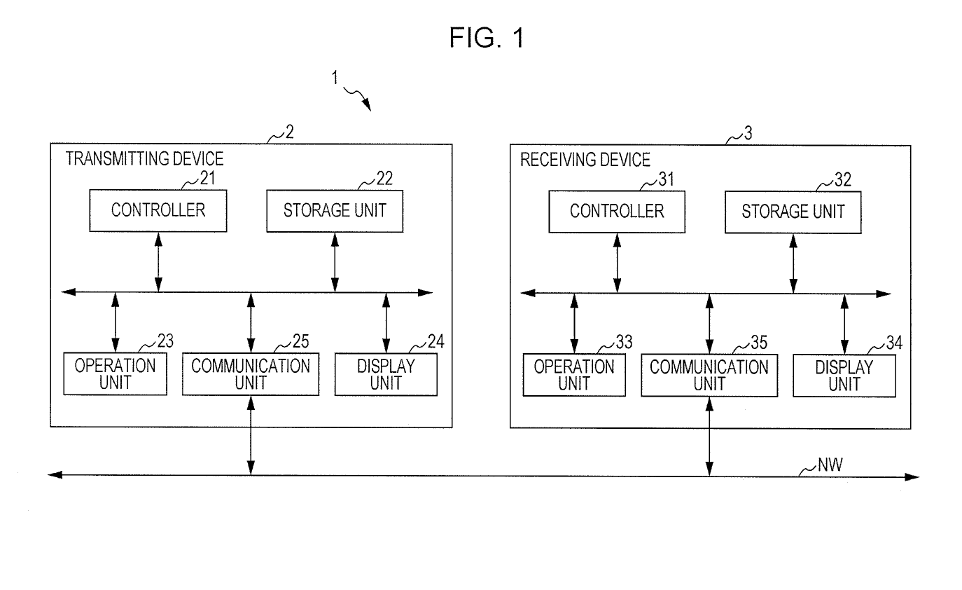

FIG. 1 is a diagram illustrating an example of a configuration of a system 1. The system 1 includes a transmitting device 2 and a receiving device 3. The transmitting device 2 and the receiving device 3 are capable of communicating with each other via a network NW.

The transmitting device 2 includes a controller 21, a storage unit 22, an operation unit 23, a display unit 24, and a communication unit 25.

The controller 21 includes a central processing unit (CPU). The controller 21 executes various types of arithmetic processing in accordance with a program stored in the storage unit 22. The controller 21 also controls the individual units of the transmitting device 2.

The storage unit 22 stores a program and data necessary for the operation of the controller 21. The storage unit 22 is also used as a work memory for the controller 21. The program may be provided from a computer-readable information recording medium, such as a compact disc-read only memory (CD-ROM), or may be provided via a communication line, such as the Internet.

The operation unit 23 includes, for example, a pointing device, such as a mouse, for outputting coordinate information to the controller 21, and a character input device, such as a keyboard, for outputting character information to the controller 21.

The display unit 24 is, for example, a thin display, such as a liquid crystal display or an organic electroluminescence (EL) display.

The communication unit 25 includes, for example, a network interface card (NIC), and communicates with another device that is connected to the network NW.

The receiving device 3 includes a controller 31, a storage unit 32, an operation unit 33, a display unit 34, and a communication unit 35. These units are similar to the controller 21, the storage unit 22, the operation unit 23, the display unit 24, and the communication unit 25 of the transmitting device 2.

In the system 1, the transmitting device 2 transmits to the receiving device 3 operation input information which is generated when a user operates the operation unit 23. The receiving device 3 executes arithmetic processing in accordance with the received operation input information, and transmits screen output information to the transmitting device 2. The transmitting device 2 displays the received screen output information on the screen of the display unit 24. That is, a so-called remote desktop is implemented by the system 1.

In this exemplary embodiment, as described below, it is possible to increase the number of types of information that are able to be transmitted and received by using the operation input information.

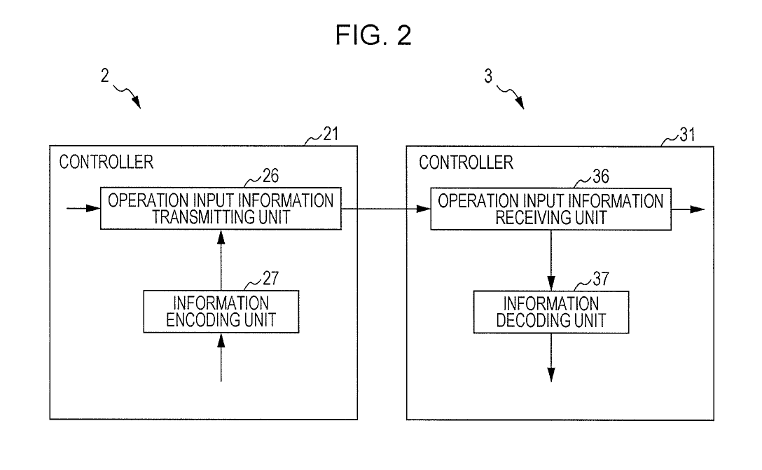

FIG. 2 is a diagram illustrating an example of a configuration of the controllers 21 and 31. The controller 21 includes an operation input information transmitting unit 26 and an information encoding unit 27, and the controller 31 includes an operation input information receiving unit 36 and an information decoding unit 37. These units are implemented when the controllers 21 and 31 execute arithmetic processing in accordance with a program.

The operation input information transmitting unit 26, the information encoding unit 27, the operation input information receiving unit 36, and the information decoding unit 37 may be implemented by a single information processing device.

In the description provided below, information supplied from the pointing device of the operation unit 23 to the operation input information transmitting unit 26 will be referred to as “position coordinate information”. The position coordinate information is an example of an operation input code which represents an operation input by a user. Furthermore, information encoded into a form of the position coordinate information, which is supplied from the information encoding unit 27 to the operation input information transmitting unit 26 will be referred to as “encoded information”. The encoded information is an example of encoded information. Moreover, a concept which encompasses the position coordinate information and the encoded information will be referred to as “operation input information”.

The operation input information transmitting unit 26 is an example of a mixing unit and an example of a transmitting unit. The operation input information transmitting unit 26 mixes the position coordinate information supplied from the operation unit 23 and the encoded information supplied from the information encoding unit 27, and transmits, as operation input information, the mixture of the position coordinate information and the encoded information to the receiving device 3.

The information encoding unit 27 is an example of an encoding unit. The information encoding unit 27 generates encoded information by encoding information which is different from the position coordinate information into the form of the position coordinate information, and supplies the encoded information to the operation input information transmitting unit 26.

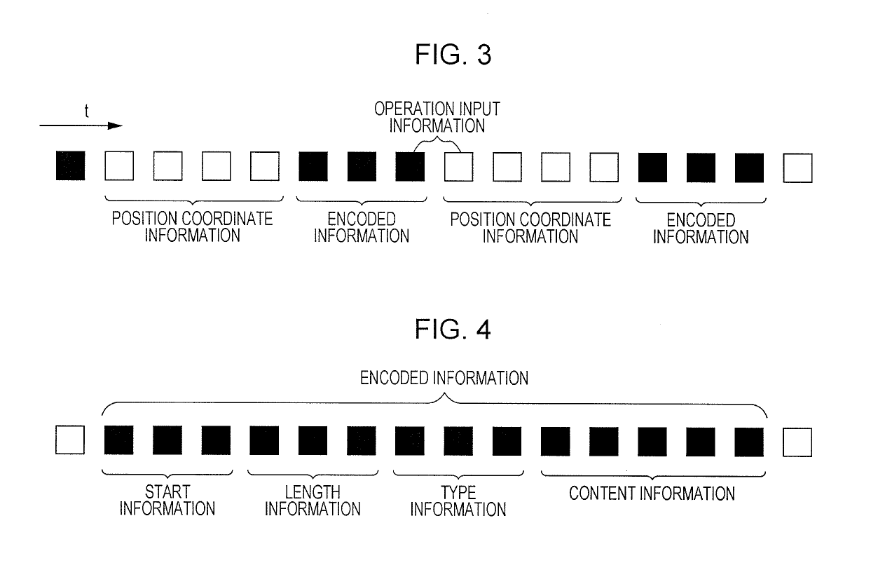

FIG. 3 is a diagram illustrating an example of the operation input information transmitted from the transmitting device 2 to the receiving device 3. FIG. 4 is a diagram illustrating an example of the encoded information included in the operation input information. FIG. 3 and FIG. 4 are schematic views for illustrating the operation input information. The number of pieces of consecutive encoded information is not limited to the illustrated examples.

The operation input information is sequentially transmitted from the transmitting device 2 to the receiving device 3. The operation input information includes position coordinate information, and a set of consecutively transmitted multiple pieces of encoded information appear periodically in the operation input information. Each piece of position coordinate information represents coordinates generated when a user operates the pointing device of the operation unit 23. Meanwhile, the set of consecutively transmitted multiple pieces of encoded information represents information different from the position coordinate information.

The position coordinate information is, for example, expressed by coordinates of a mouse cursor. In the description provided below, the format of the position coordinate information is described as MouseMove (X,Y). X represents the horizontal position on the screen and Y represents the vertical position on the screen.

Meanwhile, the encoded information is expressed by coordinates adjusted by a predetermined value with respect to reference coordinates. For example, 2-bit equivalent values “0” to “3” are expressed by four coordinates, (MouseMove (X0+5,Y0), MouseMove (X0,Y0+5), MouseMove (X0−5,Y0), and MouseMove (X0,Y0−5)), which are moved by five in either up, down, left, or right direction from reference coordinates (MouseMove (X0,Y0)). Thus, four pieces of MouseMove information are necessary to transmit information of 1 byte. The reference coordinates may be, for example, the immediately preceding transmitted coordinates or predetermined coordinates.

A set of consecutively transmitted multiple pieces of encoded information includes start information representing start of encoded information, length information representing data length, type information representing a type of information which is different from an operation input, and content information representing the content of information which is different from the operation input, in that order.

The start information is expressed by a pattern of regular and fine changes in coordinates. For example, start of encoded information is expressed by a pattern: MouseMove (X0,Y0−5)→MouseMove (X0,Y0−10)→MouseMove (X0,Y0−5)→MouseMove (X0,Y0)→MouseMove (X0−5,Y0)→MouseMove (X0−10,Y0)→MouseMove (X0−5,Y0)→MouseMove (X0,Y0). Normally, such regular and fine changes in coordinates are not generated by an operation by a user. Therefore, it is possible to distinguish between the position coordinate information and the encoded information.

Information which is different from the position coordinate information and which is expressed by a set of consecutively transmitted multiple pieces of encoded information is, for example, geographical location information acquired by a GPS function or the like. In this case, the type information indicates that the information indicates a geographical location, and the content information indicates two values: longitude and latitude. For example, when the length information has 1 byte, the type information has 1 byte, and the content information has 8 bytes (4 bytes each for longitude and latitude), with a total of 10 bytes, 40 pieces of MouseMove information are necessary. Furthermore, 48 pieces of MouseMove information, including the start information, are necessary.

Referring back to FIG. 2, the operation input information receiving unit 36 is an example of an extracting unit, and an example of a receiving unit. The operation input information receiving unit 36 receives operation input information from the transmitting device 2, and supplies the information to an operation system or an application. Furthermore, the operation input information receiving unit 36 extracts encoded information from the operation input information, and supplies the information to the information decoding unit 37.

The information decoding unit 37 is an example of a decoding unit. The information decoding unit 37 decodes the encoded information supplied from the operation input information receiving unit 36, and supplies the decoded information to an operation system or an application.

Specifically, the operation input information receiving unit 36 monitors whether or not start information (that is, a predetermined change pattern of coordinates) which represents the start of encoded information appears in the received operation input information, and starts the extraction of the encoded information when the appearance is detected. Once the extraction of the encoded information is started, the information decoding unit 37 also starts decoding. Furthermore, the operation input information transmitting unit 26 ends the extraction of the encoded information, based on the data length obtained by decoding length information which appears after the start information.

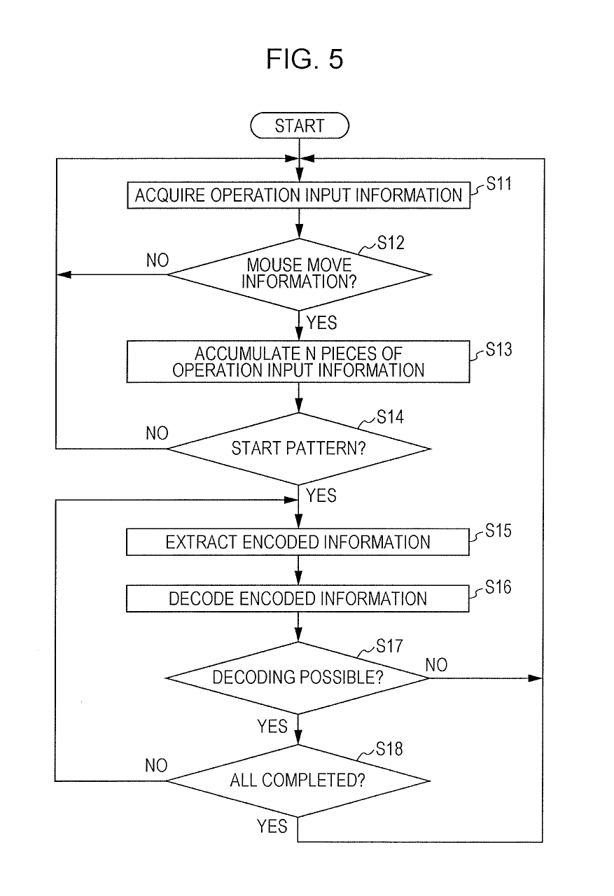

FIG. 5 is a diagram illustrating a specific example of an operation of the controller 31.

When operation input information received from the transmitting device 2 is in a form of position coordinate information (S11, S12: YES), the controller 31 accumulates the latest N pieces of operation input information (S13). N pieces are, for example, set as the number of pieces necessary for determining start information which represents the start of encoded information (that is, a predetermined change pattern of coordinates).

The controller 31 determines whether or not start information appears in the accumulated operation input information, and when start information appears (S14: YES), starts extraction of encoded information and decoding of the encoded information (S15, S16).

The extraction and decoding of the encoded information continues until extraction and decoding of data length obtained by decoding length information, which appears after the start information, is completed. That is, the extraction and decoding of the encoded information continues until the extraction and decoding of type information and content information is completed (S18).

When detecting an operation input by a user during the extraction of the encoded information, the controller 31 stops the extraction of the encoded information (S17). Specifically, upon deleting information that does not meet the rules of encoding in the encoded information during extraction, the controller 31 stops the extraction of the encoded information, assuming that an operation input by the user has started.

Without being limited to the above description, for example, when an operation input by a user starts while the encoded information is being transmitted, the controller 21 of the transmitting device 2 may transmit a predetermined change pattern of coordinates which indicates that transmission of the encoded information should be stopped. The controller 31 of the receiving device 3 may stop the extraction of the encoded information when detecting the change pattern.

The exemplary embodiments of the present invention have been described above. However, the present invention is not intended to be limited to the above exemplary embodiments, and it is obvious that various modifications may be made by those skilled in the art.

For example, the controller 21 of the transmitting device 2 may store position coordinate information immediately prior to the start of the transmission of encoded information, and may transmit the position coordinate information immediately after the transmission of the encoded information is completed, in order to avoid a positional shift of the mouse cursor between before and after the extraction of the encoded information.

Furthermore, the coordinates of a mouse cursor may be converted due to a reason, such as a difference in the resolution between the display unit 24 of the transmitting device 2 and the display unit 34 of the receiving device 3. Therefore, for example, decoding may be performed in accordance with adjustment with respect to reference coordinates by an arbitrary constant value, instead of a predetermined value.

Furthermore, a pointing device, such as a mouse, is able to output operation input information other than coordinates. Therefore, for example, encoding may be performed by using operation input information corresponding to pressing and releasing of a mouse button, operation of a mouse wheel, pressing and releasing of each key on a keyboard, or the like, or a combination thereof.

Furthermore, a keyboard is provided with a “Shift” key, a “Control” key, and an “Alternative” key, and operation input information corresponding to these keys is defined. Therefore, encoding may be performed by using operation input information corresponding to pressing and releasing of any one of these keys, or a combination thereof. In particular, normally, pressing and releasing of only one of these keys does not issue an operation instruction to an operating system or an application. Therefore, it is desirable to perform encoding by using operation input information corresponding to these keys.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A system comprising:
an encoding unit that encodes information which is different from an operation input into a form of an operation input code for representing an operation input by a user;
a mixing unit that mixes the operation input code and the encoded information;
an extracting unit that extracts the encoded information from the mixture of the operation input code and the encoded information; and
a decoding unit that decodes the extracted encoded information.

2. The system according to claim 1, wherein the encoded information represents the information which is different from the operation input, by a set of operation inputs which meet a predetermined condition.

3. The system according to claim 1,
wherein the operation input code includes coordinates generated when a user operates a pointing device, and
wherein the encoded information represents the information which is different from the operation input, by a set of coordinates which meet a predetermined condition.

4. The system according to claim 1,
wherein the operation input code includes coordinates generated when a user operates a pointing device, and
wherein the encoded information represents the information which is different from the operation input, by a set of coordinates adjusted by a predetermined value with respect to reference coordinates.

5. The system according to claim 1, wherein the encoded information includes:
information that indicates start of the encoded information;
information that indicates a length of the encoded information;
information that indicates a type of the information which is different from the operation input; and
information that indicates content of the information which is different from the operation input.

6. The system according to claim 1, wherein the extracting unit stops extraction of the encoded information when an operation input by a user is detected during the extraction of the encoded information.

7. A transmitting device comprising:
an encoding unit that encodes information which is different from an operation input into a form of an operation input code for representing an operation input by a user;
a mixing unit that mixes the operation input code and the encoded information; and
a transmitting unit that transmits the mixture of the operation input code and the encoded information.

8. A receiving device comprising:
a receiving unit that receives a mixture of an operation input code for representing an operation input by a user and information which is different from the operation input encoded into a form of the operation input code;
an extracting unit that extracts the encoded information from the mixture of the operation input code and the encoded information; and
a decoding unit that decodes the extracted encoded information.

9. A transmitting method comprising:
encoding information which is different from an operation input into a form of an operation input code for representing an operation input by a user;
mixing the operation input code and the encoded information; and
transmitting the mixture of the operation input code and the encoded information.

10. A receiving method comprising:
receiving a mixture of an operation input code for representing an operation input by a user and information which is different from the operation input encoded into a form of the operation input code;
extracting the encoded information from the mixture of the operation input code and the encoded information; and
decoding the extracted encoded information.

11. A non-transitory computer readable medium storing a program causing a computer to execute a transmitting process, the process comprising:
encoding information which is different from an operation input into a form of an operation input code for representing an operation input by a user;
mixing the operation input code and the encoded information; and
transmitting the mixture of the operation input code and the encoded information.

12. A non-transitory computer readable medium storing a program causing a computer to execute a receiving process, the process comprising:
receiving a mixture of an operation input code for representing an operation input by a user and information which is different from the operation input encoded into a form of the operation input code;
extracting the encoded information from the mixture of the operation input code and the encoded information; and
decoding the extracted encoded information.
